(19) United States
(12) Patent Application Publication
(10) Pub. No.: US 2026/0350089 A1
(43) Pub. Date: Nov. 5, 2026

(54) CONTENT MANAGEMENT FOR MEDIA SYSTEMS

(71) Applicant: HARMAN INTERNATIONAL INDUSTRIES, INCORPORATED, Stamford, CT (US)

(72) Inventors: Kevin J. BASTYR, Franklin, MI (US); Kadagattur Gopinatha SRINIDHI, Northville, MI (US)

(21) Appl. No.: 19/119,895

(22) PCT Filed: Nov. 8, 2022
(86) PCT No.: PCT/US2022/049310

§ 371 Date: Apr. 10, 2025

(51) Int. Cl. G06F 16/638; G06F 16/635

(52) U.S. Cl. CPC G06F 16/639; G06F 16/635

(57) ABSTRACT

Techniques for managing content in a media system include a computer-implemented method for managing content in an audio system include, at a first computing device, generating a first list of content items, obtaining a second list of content items associated with a second computing device, generating a collaborative playlist based on the first list and the second list, and causing at least one content item included in the collaborative playlist to be output via one or more output devices.

### BACKGROUND

### Field of the Various Embodiments

The various embodiments relate generally to entertainment systems, and more specifically, to techniques for managing content for media systems.

### Description of the Related Art

With the proliferation of mobile devices (e.g., smart phones), demand for portable, personal speakers has also increased. Personal speakers allow a user to have a speaker for enjoying audio content on the go that provides better audio quality than the speaker(s) included in a mobile device. A feature of personal speakers that is growing in popularity is a “party mode,” in which multiple personal speakers can communicatively couple together to form an ad hoc network of speakers that synchronizes together and outputs audio content as one speaker system. The party mode can be coordinated and controlled via a mobile device. Content is output from the mobile device to the network of speakers.

An issue with party mode for speakers arises when multiple users would like to provide content for playback on the network of speakers, such as when different users, each of which has different mobile devices, uses different audio content providers, and/or has different audio content preferences. A drawback of conventional party mode for speakers is that the network of speakers can only output content from one mobile device at a time. When the network of speakers is outputting content from only one device at a time, the content preferences of the other users are neglected. A response to this drawback is a “barge in” feature, where another user can stop output of content from the device of a first user and begin output of content from his or her own device. However, this “barge in” feature does not address the underlying issue of content preferences of other users being neglected when the content is provided from only one device at a time. Further, this “barge in” feature can cause undesirable conflict between the users trying to control the content being output through the network of speakers, which can result in an unpleasant listening experience in cases when the “barge in” feature results in no songs being streamed to completion.

As the foregoing illustrates, what is needed are more effective techniques for managing content for output by a media system.

### SUMMARY

Various embodiments of the present disclosure set forth a computer-implemented method for managing content in a media system include, at a first computing device, generating a first list of content items, obtaining a second list of content items associated with a second computing device, generating a collaborative playlist based on the first list and the second list, and causing at least one content item included in the collaborative playlist to be output via one or more output devices.

Further embodiments provide, among other things, one or more non-transitory computer-readable media and systems configured to implement the method set forth above.

At least one technical advantage of the disclosed techniques relative to the prior art is that, with the disclosed techniques, multiple users and devices can collaborate together to provide content for playback on using a coordinated media system. Another advantage is that content in the playlist is ordered based on the content preferences of multiple users. Accordingly, the more preferred content amongst the multiple users is played earlier in the playlist and/or played more frequently, and thus more likely to be played than content later in the playlist. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computer system configured to implement one or more aspects of the various embodiments;

FIG. 2 illustrates a coordinated audio system, according to one or more aspects of the various embodiments;

FIG. 3 illustrates an example of a collaboratively generated playlist for a coordinated audio system, according to one or more aspects of the various embodiments;

FIG. 4 illustrates another example of a collaboratively generated playlist for a coordinated audio system, according to one or more aspects of the various embodiments;

FIG. 5 illustrates yet another example of a collaboratively generated playlist for a coordinated audio system, according to one or more aspects of the various embodiments;

FIG. 6 is a flow chart of method steps for generating a collaborative playlist for a coordinated audio system, according to one or more aspects of the various embodiments;

FIG. 7 is another flow chart of method steps for generating a collaborative playlist for a coordinated audio system, according to one or more aspects of the various embodiments; and

FIG. 8 is yet another flow chart of method steps for generating a collaborative playlist for a coordinated audio system, according to one or more aspects of the various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

Although the following disclosure is described primarily with respect to the output of audio content using an ad hoc network of audio output devices, the disclosed techniques are equally applicable to video content and/or other types of content items. For example, the techniques could be used in a coordinated media system to manage and output a playlist of video content items for display using one or more video output devices, such as one or more televisions and/or computer displays. The video content items could be video content items stored on a computing device and/or provided by one or more video content providers, such as YouTube, TikTok, Vimeo, Twitch, Veoh, paid content providers, and/or the like.

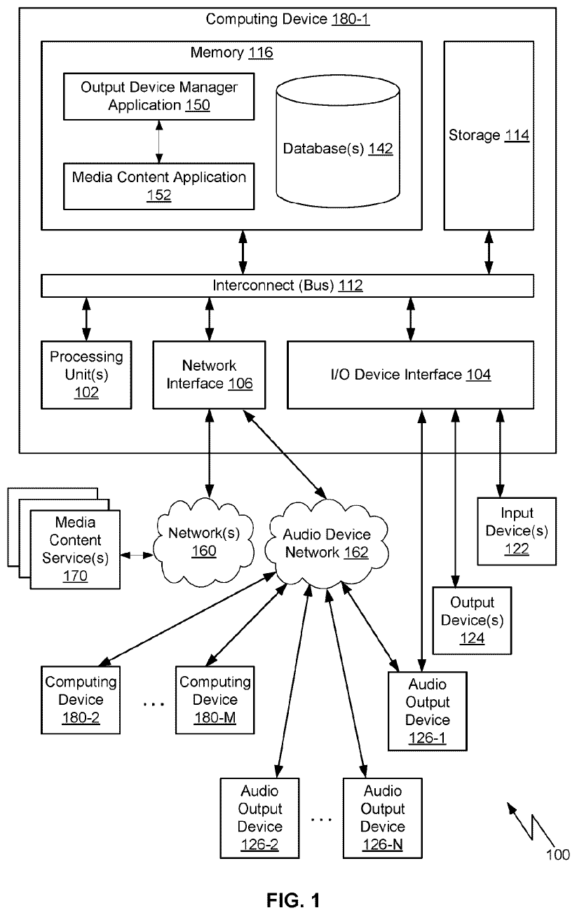

FIG. 1 illustrates a computer system 100 configured to implement one or more aspects of the various embodiments. As shown, computer system 100 includes, without limitation, one or more computing devices 180-1 to 180-M (which are also collectively referred to as computing device(s) 180 or generically as computing device 180), input devices 122, output devices 124, audio output device(s) 126, network(s) 160, audio device network 162, and media content services 170. A computing device 180 (e.g., computing device 180-1) includes, without limitation, one or more processing units 102, I/O device interface 104, network interface 106, interconnect 112 (e.g., a bus), storage 114, and memory 116. Memory 116 stores output device manager application 150 and media content application 152. Processing unit(s) 102 and memory 116 can be implemented in any technically feasible fashion. For example, and without limitation, in various embodiments, any combination of processing unit(s) 102 and memory 116 can be implemented as a stand-alone chip or as part of a more comprehensive solution that is implemented as an application-specific integrated circuit (ASIC), a system-on-a-chip (SoC), and/or the like. Processing unit(s) 102, I/O device interface 104, network interface 106, storage 114, and memory 116 can be communicatively coupled to each other via interconnect 112.

The one or more processing unit(s) 102 can include any suitable processor, such as a central processing unit (CPU), a graphics processing unit (GPU), an application-specific integrated circuit (ASIC), a field programmable gate array (FPGA), a tensor processing unit (TPU), any other type of processing unit, or a combination of multiple processing units, such as a CPU configured to operate in conjunction with a GPU. In general, each of the one or more processing unit(s) 102 can be any technically feasible hardware unit capable of processing data and/or executing software applications and modules.

Storage 114 may include non-volatile storage for applications, software modules, and data, and can include fixed or removable disk drives, solid state drives, secure digital and other flash memory devices, and CD-ROM, DVD-ROM, Blu-Ray, HD-DVD, or other magnetic, optical, solid state storage devices, and/or the like.

Memory 116 can include a random access memory (RAM) module, a flash memory unit, or any other type of memory unit or combination thereof. The one or more processing unit(s) 102, I/O device interface 104, and network interface 106 are configured to read data from and write data to memory 116. Memory 116 includes various software programs and modules (e.g., an operating system, one or more applications) that can be executed by processing unit(s) 102 and application data (e.g., data loaded from storage 114) associated with said software programs.

In some embodiments, one or more databases 142 are loaded from storage 114 into memory 116. Databases 142 include application, user data, media content, etc. that are associated with one or more applications that can be executed by processing unit(s) 102.

In some embodiments, computing device 180 is communicatively coupled to one or more networks 160. Network(s) 160 can be any technically feasible type of communications network that allows data to be exchanged between computing device 180 and other systems or devices, such as a server, a cloud computing system, or other networked computing device or system (e.g., media content service(s) 170). For example, network 160 can include a wide area network (WAN), a local area network (LAN), a wireless network (e.g., a Wi-Fi network, a cellular data network, an ad hoc network), and/or the Internet, among others. Computing device 180 can connect with network(s) 160 via network interface 106. In some embodiments, network interface 106 is hardware, software, or a combination of hardware and software, which is configured to connect to and interface with network(s) 160. In some embodiments, network interface 106 facilitates communication with other devices or systems via one or more standard and/or proprietary protocols (e.g., Bluetooth, a proprietary protocol associated with a specific manufacturer, etc.)

Media content service(s) 170 includes one or more computerized services configured to provide (e.g., distribute) media content to devices (e.g., to computing devices 180). Examples of media contents service(s) 170 include Spotify, Apple Music, Pandora, YouTube Music, Amazon Music, Tidal, Deezer, and/or the like. Media or media content as used herein, includes, without limitation, audio content (e.g., spoken and/or musical audio content, audio content files, streaming audio content, audio track of a video, and/or the like) and/or video content. Examples of media content service(s) 170 include, without limitation, media content streaming services, digital media content sellers, media servers (local and/or remote), and/or the like. More generally, media content services 170 include one or more computer systems (e.g., a server, a cloud computing system, a networked computing system, a distributed computing system, etc.) for storing and distributing media content. Computing device 180 can communicatively couple with media content service(s) 170 via network(s) 160 and download and/or stream media content from media content services 170. In some embodiments, any of the computing devices 180 can also serve as a media content service, such as when media content has been previously purchased by a user of computing device 180 and the media content is stored locally (e.g., in storage 114 and/or memory 116) and/or stored remotely (e.g., in cloud storage).

In some embodiments, media content service(s) 170 also store profile data associated with computing device 180 and/or a user associated with computing device 180. User profile data includes, without limitation, a media content library for the user within a media content service 170, user demographic data, user preferences data regarding media content, user-created and/or automatically generated playlists of media content, and/or the like. User preferences data includes, without limitation, media content consumption data, expressed or implicit preferences of the user, and/or the like. The media content consumption data can include how many times a media content item or a playlist is played, how many times a media content item is played from start to end, how many times a media content item is skipped immediately or skipped before completion, how many times a media content item was looped or repeated, which predefined playlists are played, a day of the week and a time of day a media content item is played, a day of the week and a time of day media content items of a genre is played, how many times a media content item is played recently (e.g., in the last week, in the last month), and/or the like. The expressed or implicit preferences of the user can include a “thumbs up”, an upvote, “+1” vote, a “like”, and/or the like (e.g., a vote for playing a media content item) or a “thumbs down”, a downvote, a “−1” vote, a “dislike”, and/or the like (e.g., a vote for not playing the media content item) for various media content items, ratings and/or rankings of media content items in his or her media content library, clickstream data, and/or the like. In some embodiments, at least some of a profile data is stored (e.g., cached) at computing device 180 (e.g., in databases 142). In some embodiments, the profile data is displayed in a user interface of media content application 152 and/or using an output device 124. A media content service 170 can host individual user accounts of respective users and store respective user profile data. In some embodiments, media content services 170 can also aggregate user profile data to generate non-personalized aggregate data, such as aggregate media content consumption data and/or aggregate preferences data (e.g., how many times a media content item is played across users of media content service 170, upvotes vs. downvotes of a media content item by users of media content service 170, etc.). In some embodiments, media content services 170 also aggregate user profile data across multiple computing devices 180, such as when a user or users access a same media content service 170 from multiple computing devices (e.g. a laptop computer, a smartphone, a desktop computer, a smart watch, and/or the like).

Input devices 122 include one or more devices capable of providing input. Examples of input devices 122 include, without limitation, a touch-sensitive surface (e.g., a touchpad), a microphone, a touch-sensitive screen, buttons, knobs, dials, a keyboard, a pointing device (e.g., a mouse, a stylus), and/or the like. Output devices 124 include one or more devices of providing output. Examples of output devices 124 include, without limitation, a display device, haptic devices, and/or the like. Examples of display devices include, without limitation, LCD displays, LED displays, OLED displays, AMOLED displays, touch-sensitive displays, transparent displays, projection systems, and/or the like. Additionally, input devices 122 and/or output devices 124 may include devices capable of both receiving input and providing output, such as a touch-sensitive display, and/or the like.

Audio output device(s) 126 include one or more devices capable of outputting sound. Audio output device(s) 126 include, without limitation, portable speakers, bone conduction speakers, shoulder worn and shoulder mounted headphones, glasses mounted speakers, around-neck speakers, Bluetooth, true wireless stereo (TWS) headphones or other wireless headphones, and/or the like. In some embodiments, an audio output device 126 can be coupled to computing device 180 via I/O device interface 104 and/or network interface 106 by wire or wirelessly in any technically feasible manner (e.g., Universal Serial Bus (USB), Bluetooth, ad hoc Wi-Fi).

In various embodiments, audio output device(s) 126 also include computing, communications, and/or networking capability. For example, an audio output device 126 can also include one or more processing units similar to processing unit(s) 102, memory and/or storage, and a network interface similar to network interface 106. An audio output device 126 can communicatively couple with one or more other audio output devices 126 and/or with one or more computing devices 180 via the network interface, and optionally store data.

In various embodiments, multiple audio output devices 126-1 to 126-N (which are also collectively referred to as audio output device(s) 126 or generically as audio output device 126) communicatively couple with each other and/or the computing device(s) 180 to form a coordinated media or audio system. A coordinated media audio system, as used herein, is an ad hoc network of one or more media output devices, such as an ad hoc network of one or more audio output device(s) 126 communicatively coupled with each other and communicatively coupled with one or more computing devices 180 via an audio device network 162. Ad hoc networks of audio output device(s) 126 and computing device(s) 180 include any number of one or more audio output device(s) 126 and any number of one or more computing device(s) 180. In some embodiments, an ad hoc network includes only one audio output device 126, two or more audio output devices 126 supplied by a user, two or more audio output devices 126 provided by two or more users in any combination (e.g., one user providing on audio output device 126, a second user providing two or more audio output devices 126, and/or a third user not providing any audio output device 126), and/or the like. Additionally, in some embodiments, an ad hoc network includes only one computing device 180, a same user providing two or more computing devices 180 (e.g., a smartphone and a tablet), two or more users each providing their own computing device 180, and/or the like. In some embodiments, the ad hoc network is formed in a private space (e.g., a home, a dormitory room, a backyard, and/or the like) and/or a public space (e.g., a common space in a dormitory, a park, a public venue, and/or the like). Audio device network 162 is typically a wireless network such as a Wi-Fi network, an ad hoc Wi-Fi network, a Bluetooth network, and/or the like. In some embodiments, the audio output devices 126 in the coordinated audio system operate in a “party mode.”

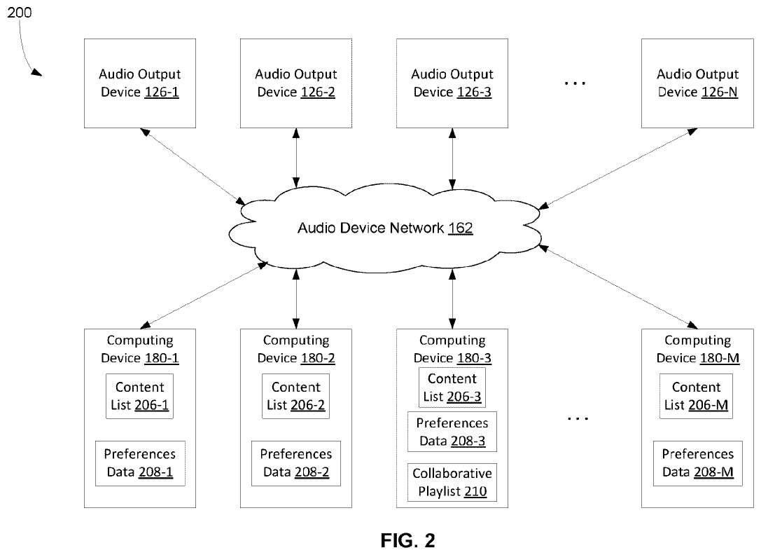

In the coordinated audio system, audio output devices 126 output media content received from a computing device 180 via audio device network 162. The audio output devices 126 output the media content in a synchronized or near-synchronized manner. In some embodiments, the coordinated audio system is initiated from one of computing device(s) 180 via output device manager application 150. For example, while computing device 180-1 is communicatively coupled to audio output device(s) 126, computing device 180-1 can send a media content item to audio output devices 126 to be synchronously output by audio output devices 126. The coordinated audio system is described in further detail in FIG. 2.

Memory 116 includes an output device manager application 150 and one or more media content applications 152. Output device manager application 150 and media content application 152 are stored in and loaded into memory 116 from storage 114. In operation, media content application 152 outputs (e.g., decodes for playback) locally stored media content (e.g., stored in storage 114) and/or media content from media content service(s) 170 via audio output device(s) 126 and/or output device(s) 124. Media content application 152 also collects and/or generates user profile data, including for example media content consumption data and preferences data. Media content application 152 also can communicate with media content service(s) 170 to obtain (e.g., purchase, rent, and/or subscribe to download, stream, or otherwise retrieve) media content for output and/or storage at one of computing devices 180, to upload user profile data to a corresponding user account at one of the media content service(s) 170, download user profile data associated with a user of any of computing device 180(s) from any of media content service(s) 170, and/or the like. In some embodiments, a media content application 152 is associated with, and can access, a specific media content service 170 (e.g., Spotify app for Spotify service, Apple Music app for Apple Music service, etc.).

Output device manager application 150 facilitates management of audio output devices 126. While a computing device 180 is communicatively coupled to audio output device(s) 126, a user can, via output device manager application 150, perform management functions for audio output device(s) 126, including but not limited to monitoring a status (e.g., battery level, volume level, firmware version, etc.) of audio output device(s) 126, configuring settings of audio output device(s) 126 (e.g., equalization settings), updating a firmware of audio output devices 126, and/or the like. In some embodiments, the preferences from users are aggregated across computing devices 180 in any of the aforementioned forms including upvoting, downvoting, averaging and/or the like to form the audio output level and/or audio equalization curve applied to media content sent to audio output device(s) 126. In some embodiments, output device manager application 150 can interface with media content application(s) 152 (e.g., via an application programming interface (API)) to cause or otherwise facilitate the sending of media content by media content application(s) 152 to audio output device(s) 126 and/or to obtain data associated with media content application(s) 152, including but not limited to media content library information and/or user profile data.

Further, in some embodiments, output device manager application 150 facilitates creation and management of the coordinated audio system. A user can, via output device manager application 150, command an audio output device 126 to join the coordinated audio system, thereby creating the coordinated audio system. Within output device manager application 150, the user can configure an individual audio output device 126 and/or configure the coordinated audio system, modify (e.g., add or remove audio output device(s) 126) or terminate the coordinated audio system, and perform other management functions associated with the coordinated audio system. Further, output device manager application 150 can generate a playlist of media content to be sent by media content application(s) 152 to audio output device(s) 126. Output device manager application 150 can generate the playlist based on explicit inputs by users and/or user profile data from computing device(s) 180 in the coordinated audio system, further details of which are described below.

FIG. 2 illustrates a coordinated audio system 200, according to one or more aspects of the various embodiments. Coordinated audio system 200 includes multiple audio output devices 126-1 through 126-N (e.g., speakers) communicatively coupled together via audio device network 162. Coordinated audio system 200 further includes computing devices 180-1 thru 180-M, communicatively coupled together via audio device network 162. Within coordinated audio system 200, a computing device 180 is communicatively coupled to zero or more audio output devices 126.

Communications in coordinated audio system 200 can use standard and/or proprietary protocols. For example, computing devices 180 can communicate with audio output devices 126 and with each other using standard protocols (e.g., Bluetooth, Wi-Fi), and audio output devices 126 can communicate with each other using standard or proprietary protocols (e.g., Bluetooth, a proprietary protocol associated with a specific manufacturer). In some embodiments, audio output devices 126 that communicate with each other using a proprietary protocol are audio output devices 126 from the same manufacturer (e.g., speakers of the same brand).

In some embodiments, one of the computing devices 180 is a leader or coordinator computing device for coordinated audio system 200. The computing device 180 from which coordinated audio system 200 is initiated can be made the leader or coordinator device, and the leader or coordinator role can be passed to another computing device 180 by user command or request. In some embodiments, the coordinator device is automatically assigned, such as when the coordinator device is the only computing device 180 with access to a sole media content service 170 or locally stored media file that is to play next on the collaborative playlist. For ease of understanding, coordinated audio system 200 is further described below with computing device 180-3 as the coordinator computing device, although any of the other computing device 180 could be the coordinator computing device.

In coordinated audio system 200, audio output devices 126 output audio corresponding to the same media content received from one source at a time. That is, a given source sends a media content item to the audio output device(s) 126, and each of the audio output device(s) 126 outputs audio corresponding to that media content item. In some embodiments, a computing device 180 transmits the data corresponding to the media content item to a first audio output device 126, and then the first audio output device transmits the data to the other audio output device(s) 126. In some embodiments, the computing device 180 transmits the data corresponding to the media content item to two or more of the audio output device(s) 126. In some embodiments, two or more of the computing devices 180 communicate among themselves to decide which of the computing devices 180 is to send the data corresponding to the media content item to the first audio output device 126 or all of the audio output devices 132. In some embodiments, the media content item is transmitted from one computing device 180 to the cloud (e.g., one of the media content service(s) 170) and then the cloud transmits the data corresponding to the media content item to the first audio output device 126 or to two or more of the audio output devices 126. In some embodiments, two or more of the computing devices 180 communicate among themselves to decide which of the computing devices 180 is to send the data corresponding to the media content item to the cloud.

While audio output devices 126 output audio corresponding to a media content item from one computing device 180 at a time, the multiple computing devices 180 can collaborate on the selection of media content items for output to audio output devices 126. In some embodiments, at each computing device 180, individual content lists 206-1 thru 206-M (e.g., a playlist of media content items) for output in coordinated audio system 200 can be generated. Content lists 206-1 thru 206-M are aggregated into a collaborative playlist 210 of media content to output to audio output devices 126. In some embodiments, computing device 180-3 sends the collaborative playlist 210 to the other computing devices 180 so that users of the other computing devices can review the collaborative playlist 210 and/or express preferences for each of the media content items in the collaborative playlist 210. A media content item in collaborative playlist 210 can be sent to audio output devices 126 from the coordinator computing device 180-3 or from the computing device 180 whose content list 206 included the media content item. In some embodiments, collaborative playlist 210 can be saved for later use and/or used as a basis for a collaborative playlist to be generated at a later time. Generation of collaborative playlists are described in further detail below.

Content lists 206 can be generated based on user inputs (e.g., a user manually adds a media content item to a content list) and/or automatically based on user profile data (e.g., user preferences, a playlist for a user, a list of “liked” songs, a list of most played songs). At a computing device 180, a user can add or remove a media content item from the corresponding content list 206 any time. As shown, computing devices 180-1 thru 180-M include preferences data 208-1 thru 208-M, respectively, associated with a user of the computing device. At a given computing device 180, one or more media content items can be suggested based on preferences data 208 and added to content list 206. Further, in some embodiments, media content items in collaborative playlist 210 can be ordered based on user inputs and/or user profile data (e.g., preferences data 208).

At a computing device 180 in coordinated audio system 200, a user can interact with coordinated audio system 200 via output device manager application 150 at the computing device 180. For example, the user at the coordinator computing device 180-3 can manage coordinated audio system 200 via output device manager application 150. Further, at a computing device 180, a user can add media content to content list 206 and/or remove media content from content list 206. Output device manager application 150 can also determine one or more media content suggestions based on one or more inputs (e.g., user inputs, user profile data, etc.) and add those suggestions to content list 206. Output device manager application 150 at the coordinator computing device 180-3 can obtain (e.g., receive) content lists 206 from the other computing devices 180, generate a collaborative playlist 210 from the content lists 206, share collaborative playlist 210 with output device manager applications 150 at the other computing devices 180, and optionally re-order the media content in collaborative playlist 210 based on one or more inputs (e.g., user profile data, user preferences). Based on the ordering of the media content in collaborative playlist 210, output device manager application 150 at the coordinator computing device 180-3 can direct the output device manager application 150 at the coordinator computing device 180-3 or the output device manager application at another computing device 180 to cause a media content item to be sent to the audio output devices 126 for output. For example, when output of media content in collaborative playlist 210 reaches a media content item that is included on content list 206-2 on computing device 180-2, output device manager application 150 at the coordinator computing device 180-3 can direct output device manager application 150 at computing device 180-2 to send that media content item to the audio output devices 126.

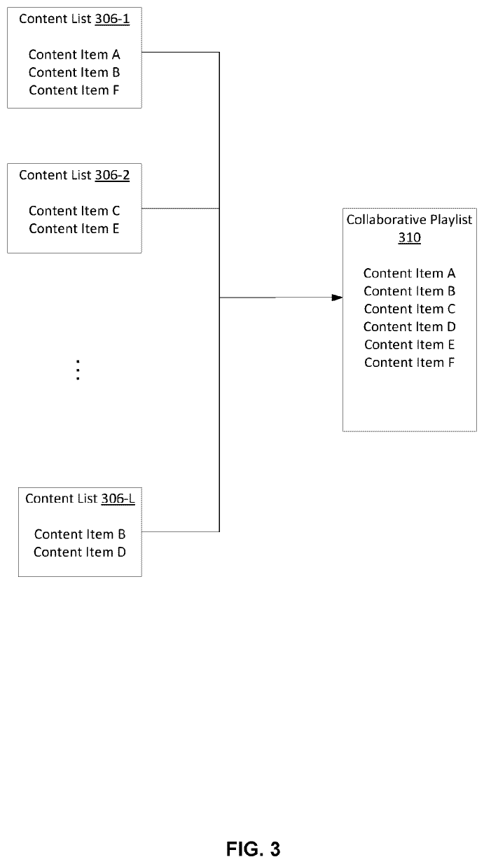

FIG. 3 illustrates an example of a collaboratively generated playlist for a coordinated audio system, according to one or more aspects of the various embodiments. FIG. 3 shows content lists 306-1 thru 306-L associated with respective multiple computing devices (e.g., computing devices 180). Each content list 306 lists media content manually added by a user to the list. For example, content list 306-1 includes Content Items A, B, and F added by a first user to content list 306-1; content list 306-2 includes Content Items C and E added by a second user to content list 306-2; and content list 306-L includes Content Item B and Content Item D added by a third user to content list 306-L. The inclusion of Content Item B in both content list 306-1 and 306-L indicates that the same content item can be included on multiple playlists. A collaborative playlist 310 can be generated by output device manager application 150 at a coordinator computing device by aggregating content lists 306. Accordingly, collaborative playlist 310 includes Content Items A thru F.

In some embodiments, the content items in collaborative list 310 can be ordered based on one or more criteria. One criterion is a timestamp when a media content item is added to a content list 306. For example, Content Items A thru F can be ordered within collaborative playlist 310 based on the timestamps when Content Items A thru F were added to their corresponding content lists 306, and Content Items A thru F are output in that order. Other criteria for ordering can include alphabetical order by title or artist, or random order.

In some embodiments, users can upvote or downvote the media content items in collaborative playlist 310, and the media content items are ordered based on the tallies of upvotes and downvotes. For example, media content items are ordered based on upvote-to-downvote differential, with the items with the larger differential placed earlier in collaborative playlist 310. The upvote/downvote criterion for ordering media content items can be used in conjunction with other criteria (e.g., items are ordered on the upvote-to-downvote differential with timestamp of addition to a content list being a tiebreaker). More generally, media content items based on user profile data (e.g., user preferences data) associated with the media content items; the user preferences data indicates preferences for media content items amongst users in a coordinated audio system. Upvotes and downvotes by users is but one example of user preferences data based on which the media content items in collaborative playlist 310 can be ordered. In some embodiments, multiple criteria (e.g., number of plays, number of playlists in which media content item is included, etc.) can be aggregated into a score or ranking for purposes of ordering collaborative playlist 310 and/or removing certain media content items from collaborative playlist 310. The criteria can be aggregated into a score or ranking using, for example, a weighted score function where the criteria are weighted by respective predefined weights.

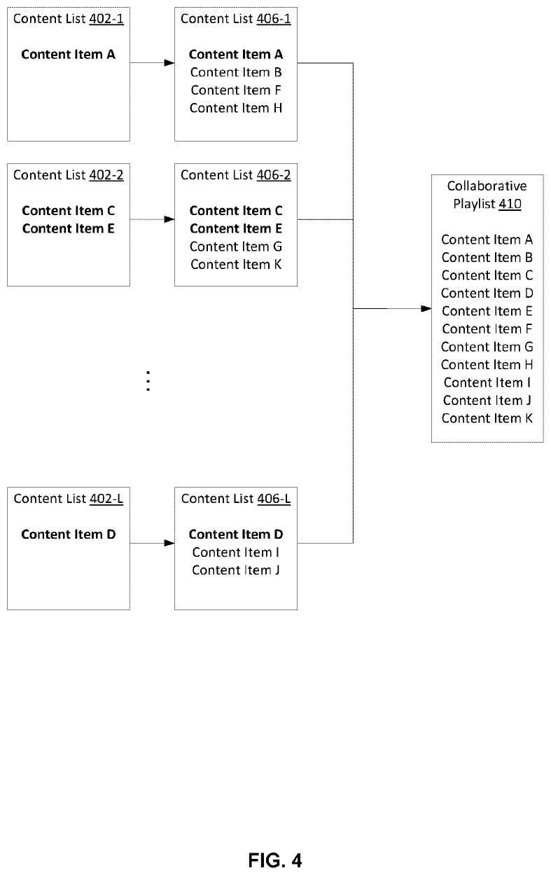

FIG. 4 illustrates another example of a collaboratively generated playlist for a coordinated audio system, according to one or more aspects of the various embodiments. FIG. 4 shows content lists 402-1 thru 402-L associated with respective multiple computing devices (e.g., computing devices 180). Each content list 402 lists media content manually added by a user to the list. For example, content list 402-1 includes Content Item A added by a first user to content list 402-1; content list 402-2 includes Content Items C and E added by a second user to content list 402-2; and content list 402-L includes Content Item D added by a third user to content list 402-L.

In some embodiments, media content items added to a content list are seed content items based on which one or more content item suggestions can be determined. In FIG. 4, the seed content items are indicated in bold text. Output device manager application 150 at a respective computing device determines one or more content item suggestions based on the seed content item(s) at the corresponding content list. For example, for content list 402-1, based on seed Content Item A, output device manager application 150 determines suggested Content Items B, F, and H. Content list 406-1 includes seed Content Item A and suggested Content Items B, F, and H. Similarly, for content list 406-2, Content Items G and K are suggested based on seed Content Items C and E. For content list 406-L, Content Items I and J are suggested based on seed Content Item D. It should be appreciated that the determination of suggested content items can be performed using any technically feasible technique including soliciting suggested content items from one of the media content services 170 or using a playlist function provided by one of the media content services 170. In some embodiments, the feature of determining suggested content items is referred to as “create a radio station” or “create a playlist” based on one or more media content items. A collaborative playlist 410 can be generated from content lists 406, with seed and suggested content items, in a similar manner as collaborative playlist 310 above. Further, media content items in collaborative playlist 410 can be ordered based on similar criteria as those described above with respect to collaborative playlist 310. In some embodiments, if output of media content items in collaborative playlist 410 is reaching the end of the playlist, an output device manager application 150 can determine additional suggested media content items based on media content items in collaborative playlist 410 and add those suggested content items to collaborative playlist 410. Additionally and/or alternatively, each of the seed content items in content lists 402 can be received at a the coordinator computing device and the aggregated content lists 402 can then be used as seed content to generate the additional media content items to extend collaborative playlist 410.

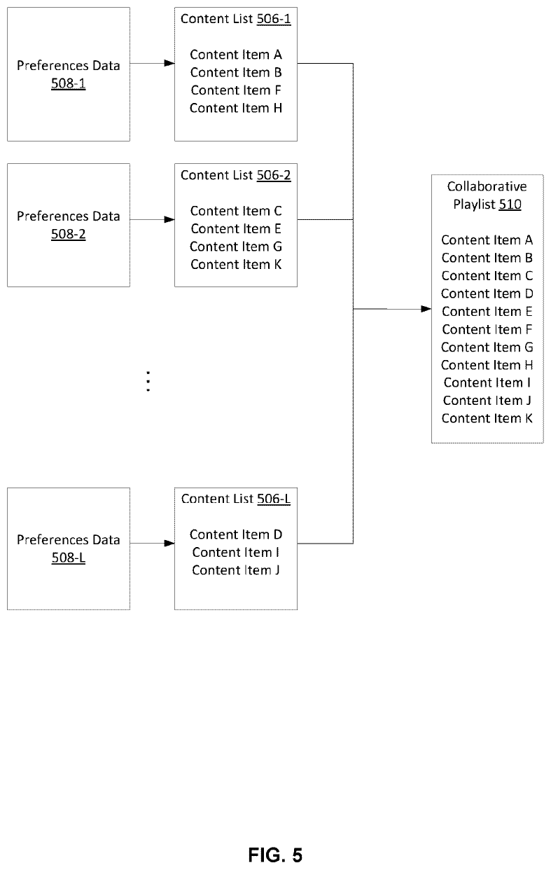

FIG. 5 illustrates yet another example of a collaboratively generated playlist for a coordinated audio system, according to one or more aspects of the various embodiments. FIG. 5 shows preferences data 508-1 thru 508-L associated with respective multiple computing devices (e.g., computing devices 180). Each preferences data 508 includes preferences data associated with a user of the corresponding computing device. Based on preferences data 508 (or user profile data more generally), output device manager application 150 can determine one or more suggested media content items and add those suggested media content items to a content list 506 at the corresponding computing device. For example, content list 506-1 is generated with Content Items A, B, F, and H; Content Items A, B, F, and H are suggested content items determined based on preferences data 508-1. Similarly, content list 506-2 is generated with Content Items C, E, G, and K; Content Items C, E, G, and K are suggested content items determined based on preferences data 508-2. Content list 506-L is generated with Content Items D, I, and J; Content Items D, I, and J are suggested content items determined based on preferences data 508-L. A collaborative playlist 510 can be generated from content lists 506 in a similar manner as collaborative playlist 310 or 410 above. Further, media content items in collaborative playlist 510 can be ordered based on similar criteria as those described above with respect to collaborative playlist 310 or 410. In some embodiments, if output of media content items in collaborative playlist 510 is reaching the end of the playlist, or if the playlist is to be extended for any other reason, an output device manager application 150 can determine additional suggested media content items based on media content items in collaborative playlist 510 and/or any of multiple content lists 506 and/or preferences data 508 and add those suggested content items to collaborative playlist 510. Additionally and/or alternatively, each of the preference data 508 can be received at the coordinator computing device and the preference data 508 can be aggregated and then used as aggregate preference data used to generate the collaborative playlist 510.

Thus, a collaborative playlist for a coordinated audio system can be generated based on content items manually added by users and/or automatically determined by output device manager application(s) 150. Suggested content items can be determined based on seed content items and/or user profile data. Media content items in the collaborative playlist can be ordered based on one or more criteria associated with user profile data or manual upvoting and downvoting.

While the above description of collaborative playlists presume that the collaborative playlist is generated and stored locally at a computing device and shared with other computing devices within the coordinated audio system, in some embodiments the collaborative playlist can be generated at and/or shared to a remote system (e.g., a cloud system). For example, user profile data and/or content lists associated with a coordinated audio system can be uploaded to a cloud system, where a collaborative playlist associated with the coordinated audio system is generated and downloaded to one or more of the computing devices in the coordinated audio system. Any portion of the collaborative playlist generation, ordering and storage may be performed on one or more computing devices, in the cloud, or even on one or more processors housed within an audio output device 126.

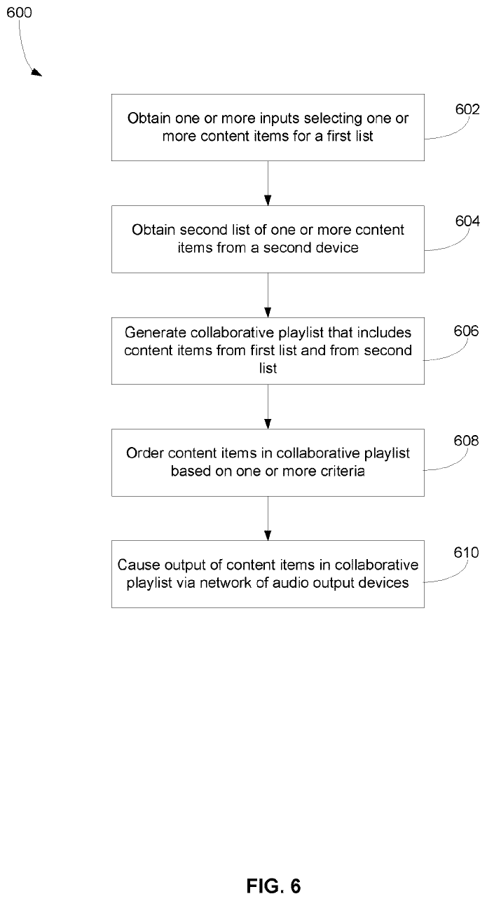

FIG. 6 is a flow chart of method steps for generating a collaborative playlist for a coordinated audio system, according to one or more aspects of the various embodiments. Although the method steps are described with respect to the systems and examples of FIGS. 1-5, persons skilled in the art will understand that any system configured to perform the method steps, in any order, falls within the scope of the various embodiments .. In some embodiments, one of more of the steps of the method in FIG. 6 can be omitted and/or additional steps (not shown) may also be performed.

As shown, a method 600 begins at step 602, where an output device manager application obtains one or more inputs selecting one or more content items for a first list. At a computing device (e.g., coordinator computing device 180-3) in a coordinated audio system, output device manager application 150 can receive inputs from a user manually adding one or more media content items to a corresponding content list (e.g., content list 206-3).

At step 604, the output device manager application obtains a second list of one or more content items from a second device. Output device manager application 150 obtains a content list (e.g., 206-2) from another computing device (e.g., computing device 180-2) in the coordinated audio system and/or any of the content lists 206, 306, 406, and/or 506.

At step 606, the output device manager application generates a collaborative playlist that includes content items from the first list and the second list. At computing device 180-3, output device manager application 150 generates a collaborative playlist 210 that includes media content items from content lists 206-3, 206-2, and other content lists 206 in the coordinated audio system. For example, in FIG. 3, collaborative playlist 310 is generated by aggregating content lists 306.

At step 608, the output device manager application orders the content items in the collaborative playlist based on one or more criteria. Output device manager application 150 orders the media content items in collaborative playlist (e.g., collaborative playlists 210, 310, 410 and/or 510) in an output or playback order based on one or more criteria including, for example, timestamps when the media content items are added to a corresponding content list, upvotes and downvotes for the media content items, and preferences data associated with the media content items. The output device manager application 150 can order the media content items in collaborative playlist using any of the techniques described herein. In some embodiments, the output device manager orders the media content items by selecting a combination of one or more methods in a predetermined manner. In some embodiments, the preferences for a user for ordering media content in the collaborative playlist is selected by choosing one or more methods from a list using input device 122 or GUI running on computing device 180 of the coordinator device or other device.

At step 610, the output device manager application causes output of the media content items in the collaborative playlist via one or more audio output devices. Output device manager application 150 at coordinator computing device 180-3 can direct media content application(s) 152 at computing device 180-3 to send the media content items in collaborative playlist 210 to audio output devices 126 in coordinated audio system 200. Alternatively, output device manager application 150 at coordinator computing device 180-3 can direct media content application(s) 152 at respective computing devices 180 to send the media content items in their respective content lists 206 to audio output devices 126. The order in which the media content items in collaborative playlist 210 are sent to audio output devices 126 is based on the order determined during step 608.

In some embodiments, method 600 can return to step 602, as further content items are be added to content lists while media content items in the collaborative playlist are being output, and thus method 600 can be repeated to update the collaborative playlist accordingly. Although not shown in FIG. 6, step 604 can be repeated multiples times for each of the computing devices providing a list of content items for the coordinated audio system and step 606 can generate the collaborative playlist further based on these additional lists of content items. As computing devices 180 enter or leave the coordinated audio system 200, items from content lists 206 can be added and removed from collaborative playlist 210 in step 606, or the influence of their user preference data can be correspondingly added or removed from the ordering of the media in the collaborative playlist at step 608 or the influence of their suggested playback level and audio equalization can be correspondingly added or removed.

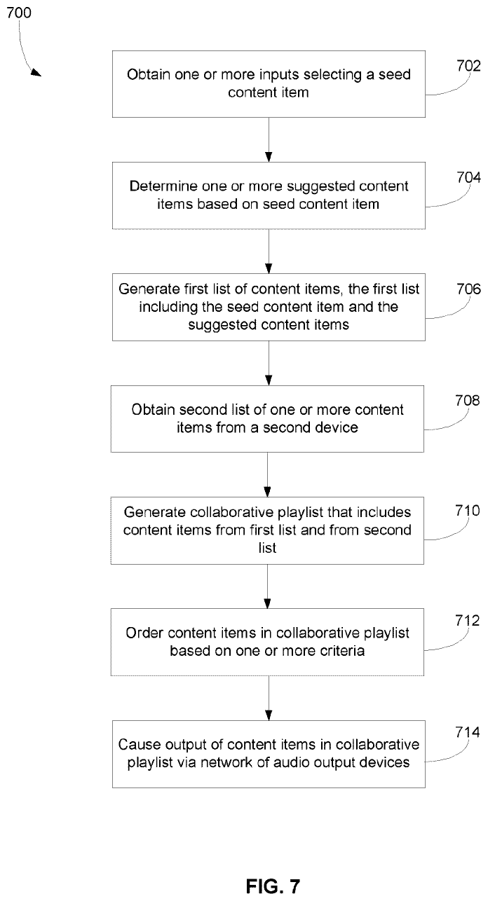

FIG. 7 is another flow chart of method steps for generating a collaborative playlist for a coordinated audio system, according to one or more aspects of the various embodiments. Although the method steps are described with respect to the systems and examples of FIGS. 1-5, persons skilled in the art will understand that any system configured to perform the method steps, in any order, falls within the scope of the various embodiments. In some embodiments, one of more of the steps of the method in FIG. 7 can be omitted and/or additional steps (not shown) may also be performed.

As shown, a method 700 begins at step 702, where an output device manager application obtains one or more inputs selecting a seed content item or seed content items. At a computing device (e.g., any of computing devices 180) in a coordinated audio system, output device manager application 150 can receive inputs from a user manually adding one or more seed content items to a corresponding content list (e.g., any of content lists 506).

At step 704, the output device manager application 150 determines one or more suggested content items based on the seed content item or seed content items. Output device manager application 150 can determine one or more suggested media content items based on the seed content item. For example, in FIG. 4, Content Items B, F, and H are suggested from seed Content Item A.

At step 706, the output device manager application generates a first list of content items that includes the seed content item and the suggested content items. Output device manager application 150 can add the seed content item and the suggested content items to the corresponding content list. For example, in FIG. 4, content list 402-1 includes seed Content Item A and suggested Content Items B, F, and H.

At step 708, the output device manager application obtains a second list of one or more content items from a second device. Step 708 is similar to step 604 of method 600 above.

At step 710, the output device manager application generates a collaborative playlist that includes content items from the first list and the second list. At step 712, the output device manager application orders the content items in the collaborative playlist based on one or more criteria. At step 714, the output device manager application causes output of the media content items in the collaborative playlist via a network of audio output devices. Steps 710, 712, and 714 are similar to steps 606, 608, and 610, respectively, of method 600

In some embodiments, method 700 can return to step 702, as further seed content items can be manually added to content lists and/or additional computing devices join or leave the coordinated audio system while media content items in the collaborative playlist are being output, and thus method 700 can be repeated to update the collaborative playlist accordingly. Additionally or alternatively, the suggested content items can be used as seed content items for determining additional suggested content items. Although not shown in FIG. 7, step 708 can be repeated multiples times for each of the computing devices providing lists content items for the coordinated audio system. Step 710 can then generate collaborative playlist further based on these additional lists of content items. Although not shown in FIG. 7, steps 702, 704 and 706 can be repeated multiples times for each of the computing devices providing seed content items for the coordinated audio system. In some embodiments, only steps 702, 704, and 706 are performed for all computing devices 180, and step 708 is omitted to form an automatically generated collaborative playlist.

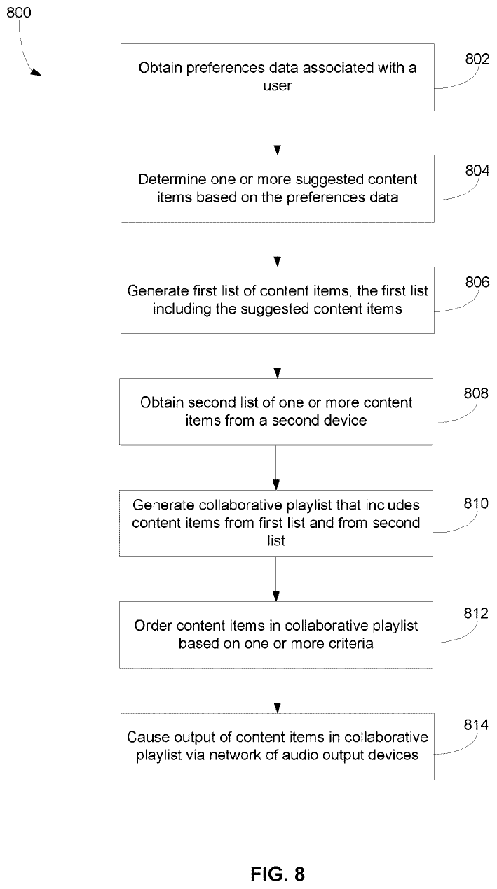

FIG. 8 is yet another flow chart of method steps for generating a collaborative playlist for a coordinated audio system, according to one or more aspects of the various embodiments. Although the method steps are described with respect to the systems and examples of FIGS. 1-5, persons skilled in the art will understand that any system configured to perform the method steps, in any order, falls within the scope of the various embodiments. In some embodiments, one of more of the steps of the method in FIG. 8 can be omitted and/or additional steps (not shown) may also be performed.

As shown, a method 800 begins at step 802, where an output device manager application obtains preferences data associated with a user. At a computing device (e.g., coordinator computing device 180-3) in a coordinated audio system, output device manager application 150 obtains preferences data 208-3 associated with a user of computing device 180-3. Output device manager application 150 can obtain preferences data 208-3 through media content application 152.

At step 804, the output device manager application determines one or more suggested content items based on the preferences data. Output device manager application 150 at computing device 180-3 can determine one or more suggested media content items based on preferences data 208-3. For example, in FIG. 5, Content Items A, B, F, and H are suggested from preferences data 508-1.

At step 806, the output device manager application generates a first list of content items that includes the suggested content items. Output device manager application 150 can add the suggested content items to the corresponding content list. For example, in FIG. 5, content list 506-1 includes suggested Content Items A, B, F, and H.

At step 808, the output device manager application obtains a second list of one or more content items from a second device. Step 808 is similar to Step 604 of method 600 above.

At step 810, the output device manager application generates a collaborative playlist that includes content items from the first list and the second list. At step 812, the output device manager application orders the content items in the collaborative playlist based on one or more criteria. At step 814, the output device manager application causes output of the media content items in the collaborative playlist via a network of audio output devices. Steps 810, 812, and 814 are similar to steps 606, 608, and 610, respectively, of method 600.

In some embodiments, method 800 can return to step 802, as further preferences data becomes available and/or as additional computing devices join or leave the coordinated audio system while media content items in the collaborative playlist are being output, and thus method 700 can be repeated to update the collaborative playlist accordingly. Although not shown in FIG. 8, step 808 can be repeated multiple times for each of the computing devices providing lists content items for the coordinated audio system. Step 810 can then generate the collaborative playlist further based on the additional preferences data and/or lists of content items. Although not shown in FIG. 8, steps 802, 804 and 806 can be repeated multiples times so that multiple computing devices can provide preferences data for the formation of a list of content items for the coordinated audio system. In some embodiments, only steps 802, 804, and 806 are performed for all computing devices 180, and step 808 is omitted to form a fully automatically generated collaborative playlist. In some embodiments, both manually added and automatically generated content items from one or more computing devices 180 form the collaborative playlist.

In sum, multiple computing devices and output devices are coupled together to form a coordinated media system. The computing devices collaborate to generate a list of content for output on the output devices. Content can be added to a list manually by a user at each computing device, and the lists of content from the computing devices are combined into a collaborative playlist. The order of output from the collaborative playlist can be determined based on time at which the content is added to a list and/or preferences of the users associated with the content in the collaborative playlist. The manually added content in the collaborative playlist can also be used to determine content suggestions that can be added to the collaborative playlist. Additionally, content for the collaborative playlist can be determined and/or ordered based on the content consumption data of the users.

At least one technical advantage of the disclosed techniques relative to the prior art is that, with the disclosed techniques, multiple users and devices can collaborate together to provide content for playback on using a coordinated media system. Another advantage is that content in the playlist is ordered based on the content preferences of multiple users. Accordingly, the more preferred content amongst the multiple users is played earlier in the playlist and/or played more frequently, and thus more likely to be played than content later in the playlist. These technical advantages provide one or more technological improvements over prior art approaches.
1. In some embodiments a computer-implemented method for managing content in a media system includes, at a first computing device generating a first list of content items, obtaining a second list of content items associated with a second computing device, generating a collaborative playlist based on the first list and the second list, and causing at least one content item included in the collaborative playlist to be output via one or more output devices.
2. The method of clause 1, wherein the one or more output devices comprises a plurality of communicatively coupled audio speakers.
3. The method of clause 1 or clause 2, wherein generating the first list of content items comprises receiving one or more user inputs adding one or more first content items to the first list.
4. The method of any one of clauses 1-3, wherein generating the collaborative playlist comprises determining one or more suggested content items based on one or more first content items in the first list and adding the one or more suggested content items to the collaborative playlist.
5. The method of any one of clauses 1-4, wherein generating the first list of content items comprises obtaining user profile data associated with a user of the first computing device, determining one or more suggested content items based on the user profile data, and adding the one or more suggested content items to the first list.
6. The method of any one of clauses 1-5, further comprising ordering a plurality of content items included in the collaborative playlist based on one or more criteria.
7. The method of any one of clauses 1-6, wherein the one or more criteria corresponds to respective timestamps associated with when each of the plurality of content items was added to the first list or the second list.
8. The method of any one of clauses 1-7, wherein the collaborative playlist includes a first content item, and wherein the one or more criteria comprises at least one of a number of votes for playing the first content item or a number of votes for not playing the first content item.
9. The method of any one of clauses 1-8, wherein causing at least one content item included in the collaborative playlist to be output via the one or more output devices comprises causing the first computing device or the second computing device to send the at least one content item included in the collaborative playlist to the one or more output devices.
10. In some embodiments, one or more non-transitory computer-readable storage media including instructions that, when executed by one or more processors at a first computing device, cause the one or more processors to perform the steps of generating a first list of content items, obtaining a second list of content items associated with a second computing device, generating a collaborative playlist based on the first list and the second list, and causing at least one content item included in the collaborative playlist to be output via one or more output devices.
11. The one or more non-transitory computer-readable storage media of clause 10, wherein generating the first list of content items comprises receiving one or more user inputs adding a first content item to the first list.
12. The one or more non-transitory computer-readable media of clause 10 or clause 11, wherein the steps further comprise ordering content items in the collaborative playlist based on at least one of a number of votes for playing the first content item by one or more users or a number of votes for not playing the first content item by the one or more users.
13. The one or more non-transitory computer-readable storage media of any one of clauses 10-12, wherein generating the collaborative playlist of content items further comprises determining one or more suggested content items based on the first content item and adding the one or more suggested content items to the first list.
14. The one or more non-transitory computer-readable storage media of any one of clauses 10-13, wherein generating the first list of content items comprises obtaining user profile data associated with a user of the first computing device, determining one or more suggested content items based on the user profile data, and adding the one or more suggested content items to the first list.
15. The one or more non-transitory computer-readable storage media of any one of clauses 10-14, wherein the user profile data comprises media content consumption data and preferences data.
16. The one or more non-transitory computer-readable storage media of any one of clauses 10-15, wherein causing the at least one content item included in the collaborative playlist to be output via the one or more output devices comprises causing the first computing device or the second computing device to send the at least one content item included in the collaborative playlist to the one or more output devices.
17. The one or more non-transitory computer-readable media of any one of clauses 10-16, wherein the steps further comprise sending the collaborative playlist to the second computing device.
18. In some embodiments, a computing device comprises a memory storing an application and one or more processors that, when executing the application, is configured to generate a first list of content items, obtain a second list of content items associated a second computing device, generate a collaborative playlist by aggregating the first list and the second list, and cause at least one content item included in the collaborative playlist to be output via one or more output devices.
19. The computing device of clause 18, wherein the one or more processors, when executing the application, is further configured to determine one or more suggested content items based on at least one of a first content item included in the first list or user profile data associated with a user and add the one or more suggested content items to the first list.
20. The computing device of clause 18 or clause 19, wherein to cause the at least one content item to be output via the one or more output devices, the computing device is configured to send the at least one content item to the one or more output devices or cause the second computing device to send the at least one content item to the one or more output devices.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, a solid state drive (SSD), a secure digital (SD) drive, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for managing content in a media system, comprising:
at a first computing device:
generating a first list of content items;
obtaining a second list of content items associated with a second computing device;
generating a collaborative playlist based on the first list and the second list; and
causing at least one content item included in the collaborative playlist to be output via one or more output devices.

2. The method of claim 1, wherein the one or more output devices comprises a plurality of communicatively coupled audio speakers.

3. The method of claim 1, wherein generating the first list of content items comprises receiving one or more user inputs adding one or more first content items to the first list.

4. The method of claim 1, wherein generating the collaborative playlist comprises:
determining one or more suggested content items based on one or more first content items in the first list; and
adding the one or more suggested content items to the collaborative playlist.

5. The method of claim 1, wherein generating the first list of content items comprises:
obtaining user profile data associated with a user of the first computing device;
determining one or more suggested content items based on the user profile data; and
adding the one or more suggested content items to the first list.

6. The method of claim 1, further comprising ordering a plurality of content items included in the collaborative playlist based on one or more criteria.

7. The method of claim 6, wherein the one or more criteria corresponds to respective timestamps associated with when each of the plurality of content items was added to the first list or the second list.

8. The method of claim 6, wherein the collaborative playlist includes a first content item, and wherein the one or more criteria comprises at least one of a number of votes for playing the first content item or a number of votes for not playing the first content item.

9. The method of claim 1, wherein causing at least one content item included in the collaborative playlist to be output via the one or more output devices comprises causing the first computing device or the second computing device to send the at least one content item included in the collaborative playlist to the one or more output devices.

10. One or more non-transitory computer-readable storage media including instructions that, when executed by one or more processors at a first computing device, cause the one or more processors to perform the steps of:
generating a first list of content items;
obtaining a second list of content items associated with a second computing device;
generating a collaborative playlist based on the first list and the second list; and
causing at least one content item included in the collaborative playlist to be output via one or more output devices.

11. The one or more non-transitory computer-readable storage media of claim 10, wherein generating the first list of content items comprises receiving one or more user inputs adding a first content item to the first list.

12. The one or more non-transitory computer-readable media of claim 11, wherein the steps further comprise ordering content items in the collaborative playlist based on at least one of a number of votes for playing the first content item by one or more users or a number of votes for not playing the first content item by the one or more users.

13. The one or more non-transitory computer-readable storage media of claim 11, wherein generating the collaborative playlist of content items further comprises:
determining one or more suggested content items based on the first content item; and
adding the one or more suggested content items to the first list.

14. The one or more non-transitory computer-readable storage media of claim 10, wherein generating the first list of content items comprises:
obtaining user profile data associated with a user of the first computing device;
determining one or more suggested content items based on the user profile data; and
adding the one or more suggested content items to the first list.

15. The one or more non-transitory computer-readable storage media of claim 14, wherein the user profile data comprises media content consumption data and preferences data.

16. The one or more non-transitory computer-readable storage media of claim 10, wherein causing the at least one content item included in the collaborative playlist to be output via the one or more output devices comprises causing the first computing device or the second computing device to send the at least one content item included in the collaborative playlist to the one or more output devices.

17. The one or more non-transitory computer-readable media of claim 10, wherein the steps further comprise sending the collaborative playlist to the second computing device.

18. A computing device comprising:
a memory storing an application; and
one or more processors that, when executing the application, is configured to:
generate a first list of content items;
obtain a second list of content items associated a second computing device;
generate a collaborative playlist by aggregating the first list and the second list; and
cause at least one content item included in the collaborative playlist to be output via one or more output devices.

19. The computing device of claim 18, wherein the one or more processors, when executing the application, is further configured to:
determine one or more suggested content items based on at least one of a first content item included in the first list or user profile data associated with a user; and
add the one or more suggested content items to the first list.

20. The computing device of claim 18, wherein to cause the at least one content item to be output via the one or more output devices, the computing device is configured to:
send the at least one content item to the one or more output devices; or
cause the second computing device to send the at least one content item to the one or more output devices.
